(19) United States
(12) Patent Application Publication
(10) Pub. No.: US 2025/0247501 A1
(43) Pub. Date: Jul. 31, 2025

(54) Simulating Depth In A Two-Dimensional Video Using Feature Detection And Parallax Effect With Backgroundless Video And An Out-Of-Band Channel

(71) Applicant: Zoom Video Communications, Inc., San Jose, CA (US)

(72) Inventors: Saar Litman, Montclair, NJ (US); Robert Allen Ryskamp, Mountain View, CA (US)

(21) Appl. No.: 18/427,332

(22) Filed: Jan. 30, 2024

(51) Int. Cl. H04N 7/15; G06T 5/50; G06T 7/194; G06T 7/70

(52) U.S. Cl. CPC H04N 7/15; G06T 5/50; G06T 7/194; G06T 7/70; G06T 2207/20221; G06T 2207/30201

(57) ABSTRACT

A video-conferencing system that simulates depth in a two-dimensional video of a remote speaker via a parallax effect. The background of the video of the remote speaker is removed and the resulting backgroundless video is combined with a background image according to poses of a viewing participant face captured by a camera. As the poses change, the orientation of the backgroundless video and the background image are changed proportionally to yield a parallax effect. The video or the backgroundless video and the background image are transferred to a client device of the viewing participant via separate channels.

### FIELD

This disclosure generally relates to a parallax effect in a video-conferencing system, and more specifically, to a parallax effect for a participant viewing a remote speaker.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a conferencing system for delivering conferencing software services in an electronic computing and communications system.

FIG. 5 is an example of a representation of parallax.

FIG. 6 is an example of a representation of a parallax effect implemented by a video-conferencing system.

FIG. 7 is an example of a block diagram of a video-conferencing system implementing a parallax effect with a backgroundless video and an out-of-band channel.

FIG. 8 is an example of a block diagram of a video-conferencing system implementing a parallax effect with a multilayer video and an in-band channel.

FIG. 9 is an example of a representation of yaw, pitch, roll, horizontal translation, and vertical translation of a face of a video-conferencing participant.

FIG. 10A is an example of a displayed background image with no perspective transformation; FIG. 10B is with vertical perspective transformation, and FIG. 10C is with horizontal perspective transformation.

FIG. 11 is a flowchart of a first example of a technique for simulating depth in a two-dimensional (2D) video of a remote speaker via a parallax effect.

FIG. 12 is a flowchart of a second example of a technique for simulating depth in a 2D video of a remote speaker via a parallax effect.

### DETAILED DESCRIPTION

Conferencing software is frequently used across various industries to support video-enabled conferences between participants in multiple locations. Conferencing software may provide features that enhance the video-conferencing experience for a viewing participant, for example, to add optical effects that add a sense of realism for the viewing participant. One such optical effect is parallax, which is a relative displacement of foreground and background objects when viewed from different locations.

Implementations disclosed herein enable a participant of a live video-conferencing session to observe a parallax effect when viewing a 2D video recording (e.g., video stream) of a remote speaker. Because a 2D video (or 2D image) does not include depth information like a three-dimensional (3D) video (or 3D image), parallax would normally not be observable. By implementing a parallax effect for 2D video, the viewing participant can observe depth information and can therefore experience a greater sense of realism during the video-conferencing live session.

In one implementation, a 2D video of the remote speaker is captured with a first camera and the background is removed therefrom. The “backgroundless” video, which may also be referred to herein as a transparent video, or a foreground video, is transmitted to a client device of the viewing participant. A second camera, of the client device, detects a feature of the viewing participant, for example, a pose of the face of the viewing participant, where the pose includes at least one of a horizontal location, a vertical location, a yaw, a pitch, or a roll. The transparent video is combined with a background image wherein an orientation of the transparent video to the background image is based on the detected pose. The second camera continues to detect poses of the viewing participant's face, so that as the viewing participant moves his face, e.g., translates horizontally, translates vertically, yaws, pitches, or rolls, the transparent video and the background image are reoriented accordingly and then redisplayed for the viewing participant. The result is that the viewing participant can observe a parallax effect as his face moves relative to the second camera.

In another implementation, a 2D video of the remote speaker is captured with a first camera, the background is removed therefrom, and a background image is added to create a multilayer video. The multilayer video is transmitted to a client device of the viewing participant. A second camera, of the client device, detects a pose of the face of the viewing participant, where the pose includes at least one of a horizontal location, a vertical location, a yaw, a pitch, or a roll. The multilayer video is displayed with an orientation between the transparent video and the background image that is based on the detected pose. The second camera continues to detect poses of the viewing participant's face, so that as the viewing participant moves his face, e.g., translates horizontally, translates vertically, yaws, pitches, or rolls, the transparent video and the background image are reoriented accordingly and then redisplayed for the viewing participant. The result is that the viewing participant can observe a parallax effect as his face moves relative to the second camera.

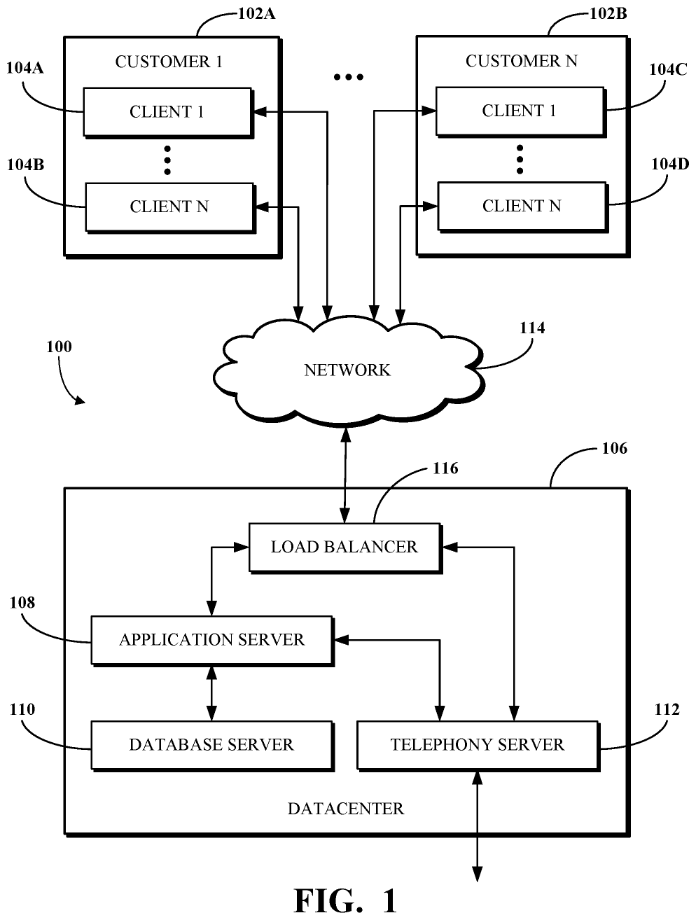

To describe some implementations in greater detail, reference is first made to examples of hardware and software structures used to implement a system for simulating depth in a 2D video using feature detection and parallax effect with either a backgroundless video and an out-of-band channel or a multilayer video and an in-band channel. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a unified communications as a service (UCaaS) platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include one or more customers and/or clients, and it can include a configuration of customers or clients different from that generally illustrated in FIG. 1. For example, and without limitation, the system 100 can include hundreds or thousands of customers, and at least some of the customers can include or be associated with one or more clients.

The system 100 includes a datacenter 106, which may include one or more servers. The datacenter 106 can represent a geographic location, which can include a facility, where the one or more servers are located. The system 100 can include one or more datacenters and servers, and it can include a configuration of datacenters and servers different from that generally illustrated in FIG. 1. For example, and without limitation, the system 100 can include tens of datacenters, and at least some of the datacenters can include hundreds or thousands of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable quantity of each of the servers 108 through 112 can be implemented at the datacenter 106. The UCaaS platform can use a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed to deliver software services to a client, such as one of the clients 104A through 104D, as part of a software application. The application node can be implemented using processing threads, virtual machine instantiations, or other computing features of the application server 108. In some such implementations, the application server 108 can include a suitable quantity of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, an SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired (e.g., electrical or optical), wireless (e.g., electromagnetic, optical), use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

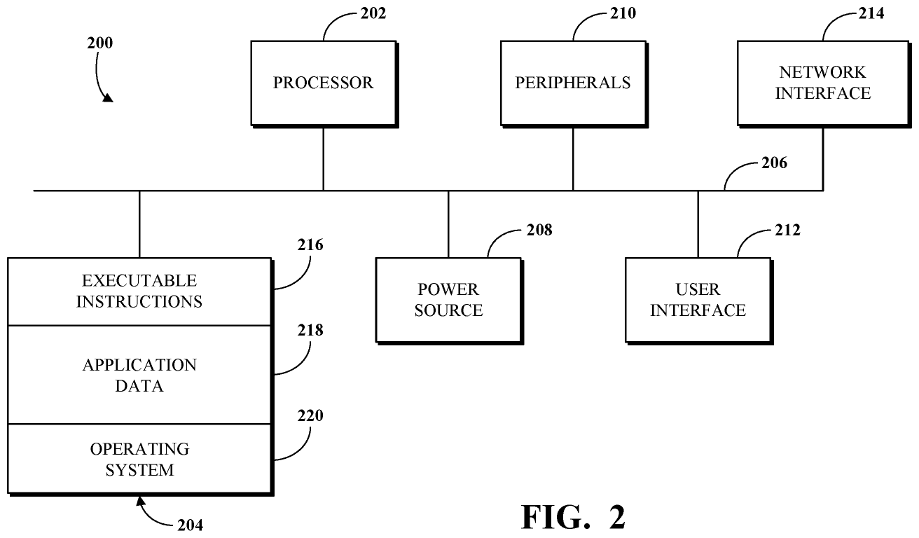

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

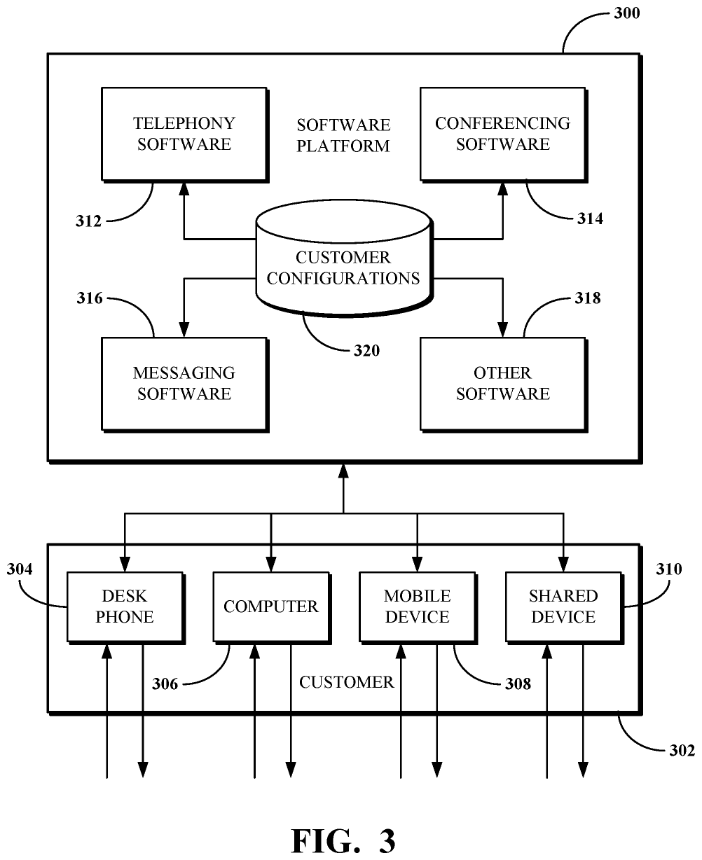

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients: a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which case the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one example, an instance of the other software 318 can be implemented in a client device of a remote speaker for removing the background of a video capture, and a different instance of the background software 318 can be implemented in a client device of a viewing participant for detecting a pose of a face of the viewing participant and for combining a transparent video with a background image with an orientation according to the detected pose. In another example, an instance of the other software 318 can be implemented in a client device of a remote speaker for removing the background of a video capture and combining a transparent video with a background image into a multilayer video, and a different instance of the background software 318 can be implemented in a client device of a viewing participant for detecting a pose of a face of the viewing participant and reorienting the transparent video and the background image according to the detected pose.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310. Terms “run” and “execute” as used herein with reference to software may be synonymous.

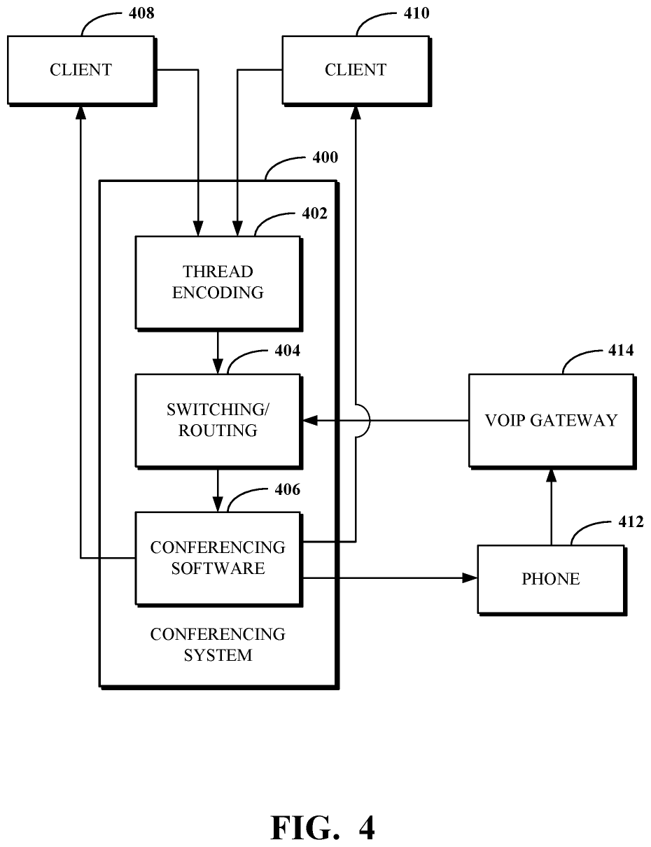

FIG. 4 is a block diagram of an example of a conferencing system 400 for delivering conferencing software services in an electronic computing and communications system, for example, the system 100 shown in FIG. 1. The conferencing system 400 includes a thread encoding tool 402, a switching/routing tool 404, and conferencing software 406. The conferencing software 406, which may be, for example, the conferencing software 314 shown in FIG. 3, is software for implementing conferences (e.g., video conferences) between users of clients and/or phones, such as clients 408 and 410 and phone 412. For example, the clients 408 or 410 may each be one of the clients 304 through 310 shown in FIG. 3 that runs a client application associated with the conferencing software 406, and the phone 412 may be a telephone which does not run a client application associated with the conferencing software 406 or otherwise access a web application associated with the conferencing software 406. The conferencing system 400 may in at least some cases be implemented using one or more servers of the system 100, for example, the application server 108 shown in FIG. 1. Although two clients and a phone are shown in FIG. 4, other quantities of clients and/or other quantities of phones can connect to the conferencing system 400.

Implementing a conference includes transmitting and receiving video, audio, and/or other data between clients and/or phones, as applicable, of the conference participants. Each of the client 408, the client 410, and the phone 412 may connect through the conferencing system 400 using separate input streams to enable users thereof to participate in a conference together using the conferencing software 406. The various channels used for establishing connections between the clients 408 and 410 and the phone 412 may, for example, be based on the individual device capabilities of the clients 408 and 410 and the phone 412.

The conferencing software 406 includes a user interface tile for each input stream received and processed at the conferencing system 400. A “user interface tile” as used herein generally refers to a portion of a conferencing software user interface which displays information (e.g., a rendered video) associated with one or more conference participants. A user interface tile may, but need not, be generally rectangular. The size of a user interface tile may depend on one or more factors including the view style set for the conferencing software user interface at a given time and whether the one or more conference participants represented by the user interface tile are active speakers at a given time. The view style for the conferencing software user interface, which may be uniformly configured for all conference participants by a host of the subject conference or which may be individually configured by each conference participant, may be one of a gallery view in which all user interface tiles are similarly or identically sized and arranged in a generally grid layout or a speaker view in which one or more user interface tiles for active speakers are enlarged and/or arranged in a center position of the conferencing software user interface while the user interface tiles for other conference participants are reduced in size and/or arranged near an edge of the conferencing software user interface. In some cases, the view style or one or more other configurations related to the display of user interface tiles may be based on a type of video conference implemented using the conferencing software 406 (e.g., a participant-to-participant video conference, a contact center engagement video conference, or an online learning video conference, as will be described below).

The content of the user interface tile associated with a given participant may be dependent upon the source of the input stream for that participant. For example, where a participant accesses the conferencing software 406 from a client, such as the client 408 or 410, the user interface tile associated with that participant may include a video stream captured at the client and transmitted to the conferencing system 400, which is then transmitted from the conferencing system 400 to other clients for viewing by other participants (although the participant may optionally disable video features to suspend the video stream from being presented during some or all of the conference). In another example, where a participant accesses the conferencing software 406 from a phone, such as the phone 412, the user interface tile for the participant may be limited to a static image showing text (e.g., a name, telephone number, or other identifier associated with the participant or the phone 412) or other default background aspects since there is no video stream presented for that participant.

The thread encoding tool 402 receives video streams separately from the clients 408 and 410 and encodes those video streams using one or more transcoding tools, such as to produce variant streams at different resolutions. For example, a given video stream received from a client may be processed using multi-stream capabilities of the conferencing system 400 to result in multiple resolution versions of that video stream, including versions at 90p, 180p, 360p, 720p, and/or 1080p, amongst others. The video streams may be received from the clients over a network, for example, the network 114 shown in FIG. 1, or by a direct wired connection, such as using a universal serial bus (USB) connection or like coupling aspect. After the video streams are encoded, the switching/routing tool 404 directs the encoded streams through applicable network infrastructure and/or other hardware to deliver the encoded streams to the conferencing software 406. The conferencing software 406 transmits the encoded video streams to each connected client, such as the clients 408 and 410, which receive and decode the encoded video streams to output the video content thereof for display by video output components of the clients, such as within respective user interface tiles of a user interface of the conferencing software 406.

A user of the phone 412 participates in a conference using an audio-only connection and may be referred to an audio-only caller. To participate in the conference from the phone 412, an audio signal from the phone 412 is received and processed at a VOIP gateway 414 to prepare a digital telephony signal for processing at the conferencing system 400. The VOIP gateway 414 may be part of the system 100, for example, implemented at or in connection with a server of the datacenter 106, such as the telephony server 112 shown in FIG. 1. Alternatively, the VOIP gateway 414 may be located on the user-side, such as in a same location as the phone 412. The digital telephony signal is a packet switched signal transmitted to the switching/routing tool 404 for delivery to the conferencing software 406. The conferencing software 406 outputs an audio signal representing a combined audio capture for each participant of the conference for output by an audio output component of the phone 412. In some implementations, the VOIP gateway 414 may be omitted, for example, where the phone 412 is a VOIP-enabled phone.

A conference implemented using the conferencing software 406 may be referred to as a video conference in which video streaming is enabled for the conference participants thereof. The enabling of video streaming for a conference participant of a video conference does not require that the conference participant activate or otherwise use video functionality for participating in the video conference. For example, a conference may still be a video conference where none of the participants joining via clients turns on their video stream for any portion of the conference. In some cases, however, the conference may have video disabled, such as where each participant connects to the conference using a phone rather than a client, or where a host of the conference selectively configures the conference to exclude video functionality.

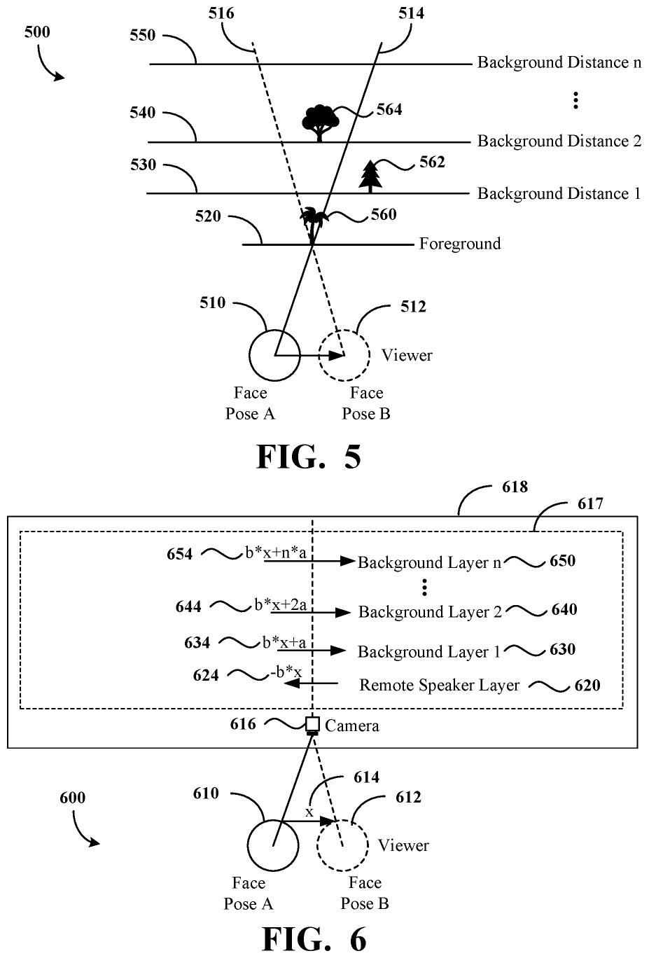

FIG. 5 shows an example of a representation 500 of parallax. In this example the background is quantized into discrete distances for illustrative purposes, where in a real-world observation of a scene the background would be continuous. A viewer whose face (e.g., head) is at location 510 (labeled as Pose A) would observe a foreground 520 and backgrounds at distances 530, 540, and 550 according to the solid line 514. For example, the background object 562 would appear to the right of the foreground object 560 and the background object 564 would appear to the left of the foreground object 560. When the viewer moves his face to a new location 512 (labeled Pose B), while continuing to focus on the foreground object 560, the viewer would observe different points at each of the background distances 530, 540, and 550, as indicated by the dashed line 516. From this new location 512, the background object 562 would appear to be nearly twice as far to the right of the foreground object 560 as it was at the previous viewing location 510, and the background object 564 would now appear to be to the right of the foreground object 560 whereas before it appeared to the left. To the viewer, the background objects 562 and 564 appear to have moved relative to the foreground object 560. This is parallax.

FIG. 6 shows an example of a representation 600 of a parallax effect implemented by a video-conferencing system. The video-conferencing system may be the conferencing system 400 of FIG. 4, for delivering conferencing software services in an electronic computing and communications system, for example, the system 100 shown in FIG. 1. A viewing participant is located in front of a camera 616, for example, at the location 610 (labeled Pose A) or at the location 612 (labeled Pose B). The camera 616 may be a component that is integrated with or operatively coupled to a client device 618. For example, the camera 616 may be implemented as an instance of the user interface 212 of the computing device 200 of FIG. 2.

The client device 618 comprises (or is operatively coupled to) a graphical display 617, which may be another instance of the user interface 212 of the computing device 200 of FIG. 2. The display 617 displays a video with at least two layers; in FIG. 6, four layers are depicted. A first layer is the remote speaker layer 620, which may be referred to herein as a “foreground layer,” that includes the video of the remote speaker captured by a camera at the remote speakers' location. As will be described in more detailed later herein, the background of the video of the remote speaker has been removed, such that the remote speaker layer 620 is a backgroundless (i.e., transparent or foreground) video of the remote speaker. Second, third, and fourth layers are the background layers 630, 640, and 650 (labeled Background Layers 1, 2, and n, respectively) that appear behind the remote speaker layer 620. These background layers are comprised in a multilayer background image, which may simply be referred to herein as a background image regardless of how many layers it contains. In some implementations, the background image may include one or more pre-foreground layers, which are layers that are in front of the remote speaker layer 620. In some implementations, the background image is a real (e.g., photographic) or virtual (e.g., rendered) “still” image, i.e., not a live video background. The terms “video,” “video recording,” and “video stream” may be used interchangeably herein to refer to a video that is captured by a camera.

FIG. 6 indicates that when the viewing participant moves his face from location 610 to location 612, by a distance 614 of x as captured by the camera 616, the client device 618 reorients the remote speaker layer 620 with the background layers 630, 640, and 650 by a linear function of x. A convenient unit for x is pixels; however, other units may be used, such as millimeters, and the distance may even be expressed in terms of angular distance, such as degrees. The reorienting, which includes relative translations of the respective layers, may be implemented by software instructions, such as the other software 318 of FIG. 3, executing on a processor of the client device, such as the processor 202 of FIG. 2. In the example of FIG. 6, the linear function 624 for translating the remote speaker layer is −b*x, where −b is a scalar and the negative sign indicates the direction of translation is opposite of the direction of movement of the viewers face. The linear function 634 for translating the first background layer 630 is b*x+a; the linear function 644 for translating the second background layer 640 is b*x+2a, and the linear function 654 for translating the nth background layer 650 is b*x+n*a. Other linear functions may be used instead, such as −b*x for the remote speaker layer 620 and b*x, 2b*x, and n*b*x for the background layers 630, 640, and 640. In some implementations, nonlinear functions may be used for translating one or more layers.

The linear functions in the example described above may be appropriate for virtual distances between adjacent layers of the displayed video that are approximately equal to each other. In some implementations, the virtual distance between the remote speaker layer 620 and the first background layer 630, and the virtual distances between the respective background layers 630, 640, and 650, may be substantially different. For example, the first background layer 630 may depict a bookcase located two feet behind the remote speaker of the remote speaker layer 620; the second background layer 640 may depict a tree located 20 feet behind the bookcase, and the third background layer 650 may depict a mountain located 1 mile behind the tree. In such case, the linear function for translating a respective layer within a video frame may be a function of the virtual distance from the remote speaker layer 620. In some implementations, the background image may include, or encode, the virtual distance for at least one layer of the background image, for use in the linear function for translating that layer within a video frame.

Although FIG. 6 depicts a parallax effect implemented by a video-conferencing system having one viewing participant and one remote speaker, the parallax effect may be implemented by a video-conferencing system having multiple viewing participants, each participating in a video-conferencing live session using a respective client device 618 and a respective camera 616, and multiple remote speakers, each also participating in the live session using a respective client device 618 and a respective camera 616. In a first example, consisting of one viewing participant and multiple remote speakers, video of each remote participant may be presented to the viewing participant in a respective user interface tile with a respective background, and the viewing participant may observe a parallax effect for each user interface tile. In a second example, also consisting of one viewing participant and multiple remote speakers, video of each remote participant may be presented to the viewing participant in a single user interface tile with a shared background, which may sometimes be referred to as an “immersive” or “together” mode, and the viewing participant may observe a parallax effect for the single interface tile. In a third example, consisting of multiple viewing participants and one remote speaker, each viewing participant may observe a parallax effect for the user interface tile of the remote speaker depending on, for example, whether the parallax effect is enabled on a respective viewing participant's client device 618 and/or whether the respective viewing participant's client device 618 is configured to implement the parallax effect (e.g., whether the client device 618 is operatively coupled to a camera 616). In a fourth example, consisting of multiple viewing participants and multiple remote speakers, there are at least two scenarios (in addition to the scenarios described immediately above). In one scenario, a viewing participant may observe a parallax effect for only one user interface tile of one remote speaker at a time, for example, a remote speaker who is actively speaking (e.g., who has been designated as an “active speaker”). In another scenario, a viewing participant may observe a parallax effect for more than one user interface tile of more than one remote speaker at a time, for example, regardless of which remote speaker is actively speaking (e.g., which has been designated as an “active speaker”).

In some implementations, additional transformations may be carried out on the layers of the background image according to the pose of the viewing participant's face. For example, FIG. 10A shows an example of a displayed background image layer (shown as a rectangle with crisscrossing lines) as seen be a viewing participant with no perspective transformation. FIG. 10B shows an example of the background image as seen by a viewing participant with vertical perspective transformation determined according to a pose of the face pitching downward. As the face pitches downward, the distance between the eyes of the viewing participant and the top of the background layer becomes larger than the distance between the eyes and the bottom of the background layer. The shown vertical perspective transformation simulates this effect. The opposite distance relationship results from an upward pitch. FIG. 10C shows an example of the background image as seen by a viewing participant with horizontal perspective transformation determined according to a pose of the face yawing leftwards. As the face yaws leftward, the distance between the eyes of the viewing participant and the right of the background layer becomes larger than the distance between the eyes and the left of the background layer. The shown horizontal perspective transformation simulates this effect.

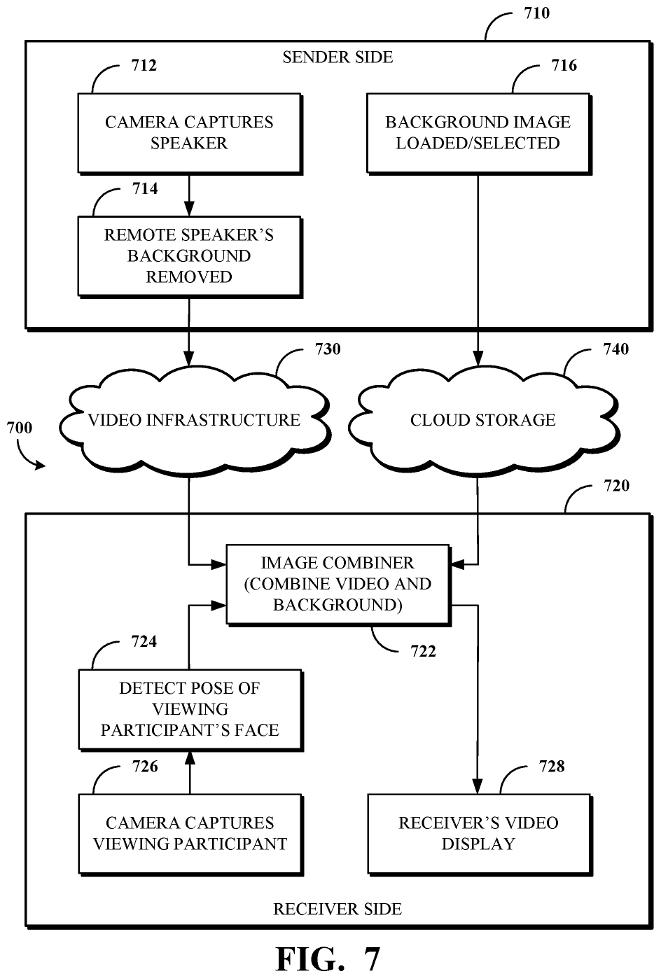

FIG. 7 shows an example of a block diagram of a video-conferencing system 700 implementing a parallax effect with a backgroundless video and an out-of-band channel. The video-conferencing system may be the conferencing system 400 of FIG. 4, for delivering conferencing software services in an electronic computing and communications system, for example, the system 100 shown in FIG. 1. The video conferencing system 700 includes: a sender side 710, which may be for example, a client device, such as the computing device 200 of FIG. 2; and a receiver side 720, which may be, for example, another client device such, as another instance of the computing device 200 of FIG. 2.

The sender side 710 comprises: a camera, such as an instance of the user interface 212 of FIG. 2, for capturing video of a speaker as indicated in block 712; and a processor, such as the processor 202 of FIG. 2, for removing the background from the video captured by the camera as indicated in block 714. In some implementations, the sender side 710 uploads a background image to a cloud storage 740, as indicated by block 716. The background image may be a single-layer image or it may be a multilayer image comprising a plurality of layers. The cloud storage 740 may be implemented by one or more servers, such as the application server 108 or the database server 110 of FIG. 1. The sender side 710 transmits the transparent video to the receiver side 720 via a video infrastructure 730, which may include the network 114 and one or more components of the datacenter 106 of FIG. 1. In some implementations, the background may be selected from a prepopulated list of backgrounds. If the prepopulated list is served by the cloud storage 740, then the sender side 710 would not need to upload the selected image to the cloud storage 740. If the prepopulated list is served by some other server or computing device, then the sender side 710 could download the selected image from the other server or computing device and subsequently upload the selected image to the cloud storage 740, or the sender side 710 could instruct the other server or computing device to upload the selected background image directly to the cloud storage 740.

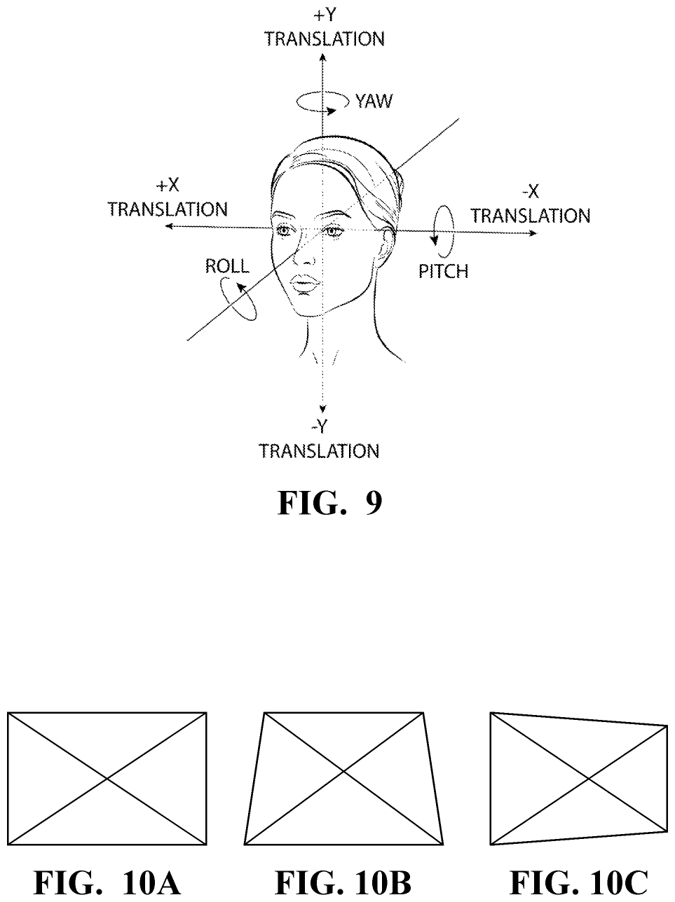

The receiver side 720 receives the transparent video via the video infrastructure 730, which may be referred to as a primary communication channel, and further receives, or retrieves, the background image from the cloud storage 740, which may be referred to as a secondary or out-of-band communication channel. The receiver side 720 comprises: a camera, such as an instance of the user interface 212 of FIG. 2, for capturing video of a viewing participant as indicated in block 726; and a processor, such as the processor 202 of FIG. 2, for determining a pose of the face of the viewing participant. As shown in FIG. 9, a pose of a face may include a horizontal location (or X translation), a vertical location (or Y translation), a yaw, a pitch, or a roll. These components combine to yield a given spatial location of the eyes of the viewing participant, which is the ultimate determinant of the viewing participant's point of view with respect to the camera of the receiver side 720. The terms face pose, head pose, and eyes pose are used interchangeably herein, and are an example of a detected feature.

The receiver side 720 further comprises a processor, such as the processor 202 of FIG. 2, for combining the transparent video and the background image into a multilayer video, where the orientation of each background layer of the background image with respect to the transparent video is based on the detected face pose, as indicated in block 722. The processor that performs operations indicated by block 722 may be a same or different processor that performs operations indicated by block 724. The receiver side 720 includes a graphical display 728 for displaying the multilayer video to the viewing participant. The orientation of each background layer with respect to the transparent video may be determined as described above, thereby implementing a parallax effect that the viewing participant can observe when he moves his head relative to the camera of the receiver side 720.

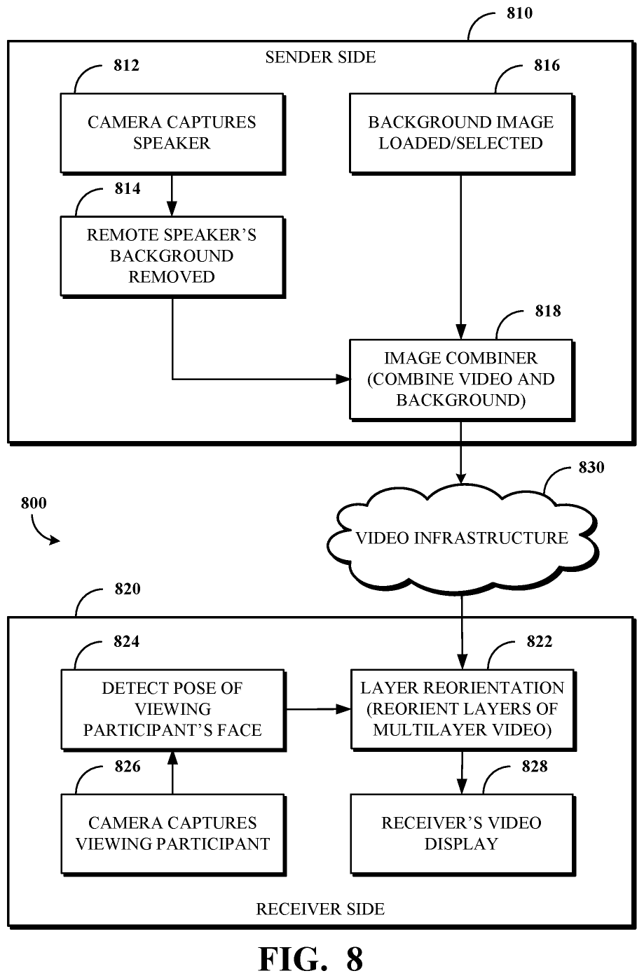

FIG. 8 shows an example of a block diagram of a video-conferencing system 700 implementing a parallax effect with a multilayer video and an in-band channel. The video-conferencing system may be the conferencing system 400 of FIG. 4, for delivering conferencing software services in an electronic computing and communications system, for example, the system 100 shown in FIG. 1. The video conferencing system 800 includes: a sender side 810, which may be for example, a client device, such as the computing device 200 of FIG. 2; and a receiver side 820, which may be, for example, another client device, such as another instance of the computing device 200 of FIG. 2.

The sender side 810 comprises: a camera, such as an instance of the user interface 212 of FIG. 2, for capturing video of a speaker as indicated in block 812; and a processor, such as the processor 202 of FIG. 2, for removing the background from the video captured by the camera as indicated in block 714. The sender side 810 further comprises a processor, such as the processor 202 of FIG. 2, for creating a multilayer video by combining a background image selected in block 816 with the transparent video as indicated in block 818. The background image may be a single-layer image or it may be a multilayer image comprising a plurality of layers. In some implementations, the background may be selected from a file system accessible by the sender side 810 or from a remote storage device, such as a cloud storage that may be implemented by the application server 108 and/or the database server 110 of FIG. 1. In some implementations, the background image may be selected from a prepopulated list of backgrounds. The sender side 810 transmits the multilayer video to the receiver side 820 via a video infrastructure 830, which may include the network 114 and one or more components of the datacenter 106 of FIG. 1.

The receiver side 820 receives the multilayer video via the video infrastructure 830, which may be referred to as a primary communication channel. Because the background image is included in the multilayer video, the background image may be said to be transmitted in-band, i.e., via the primary communication channel. The receiver side 820 comprises: a camera, such as an instance of the user interface 212 of FIG. 2, for capturing video of a viewing participant as indicated in block 826; and a processor, such as the processor 202 of FIG. 2, for determining a pose of the face of the viewing participant. As shown in FIG. 9, a pose of a face may include a horizontal location (or X translation), a vertical location (or Y translation), a yaw, a pitch, or a roll. These components combine to yield a given spatial location of the eyes of the viewing participant, which is the ultimate determinant of the viewing participant's point of view with respect to the camera of the receiver side 820. The terms face pose, head pose, and eyes pose are used interchangeably herein.

The receiver side 820 further comprises a processor, such as the processor 202 of FIG. 2, for reorienting the transparent video and the background image that are included in the received multilayer video, where the reorientation of each background layer of the background image with respect to the transparent video is based on the detected face pose, as indicated in block 822. The processor that performs operations indicated by block 822 may be a same or different processor that performs operations indicated by block 824. The receiver side 820 includes a graphical display 828 for displaying the multilayer video to the viewing participant. The reorientation of each background layer with respect to the transparent video may be determined as described above, thereby implementing a parallax effect that the viewing participant can observe when he moves his head relative to the camera of the receiver side 820.

The in-band and out-of-band implementations described above, such as with respect to FIGS. 7 and 8, may perform differently based on available computational and network resources. For example, the in-band implementation creates a multilayer video at the sender side 810, likely alleviating some computational burden on the receiver side 820. But the multilayer video will typically require greater bandwidth to transmit over a network than the out-of-band implementation because the background layers of the background image are included in all (or most) of the video frames sent by the sender side 810, whereas in the out-of-band implementation, the background image is sent just once by the sender side 710. Additionally, the in-band option enables simple integration of live-video backgrounds, where a live-video background may be captured from a second camera at the sender side and/or the live-video background may be a virtual video generated at the sender side. A live-video background may be implemented as a 2D or 3D video.

In the out-of-band implementation described above, the background of the video captured of the remote speaker is removed at the sender side 710. While this may be advantageous to minimize processing latency, in some implementations, the background can be removed at the receiver side 720. In such case, a processor at the receiver side 720 would remove the background from the received video prior to performing the operations indicated by the block 722 (image combiner). In some implementations, the background can be removed by the video infrastructure (between the sender side and the receiver side), for example the video infrastructure 730 of FIG. 7.

The in-band and out-of-band implementations described above, the described processing is performed by a client device of the sender side 710 or 810 or a client device of the receiver side 720 or 820. However, in some implementations, some of the described processing can be performed by one or more third devices, such as a server of the video infrastructure 730 or 830, for example, an application server 108 or a database server 110. If such servers are used in this manner, care should be taken to minimize processing latency caused by communication delays, as such latencies can detract from the realism of the parallax effect.

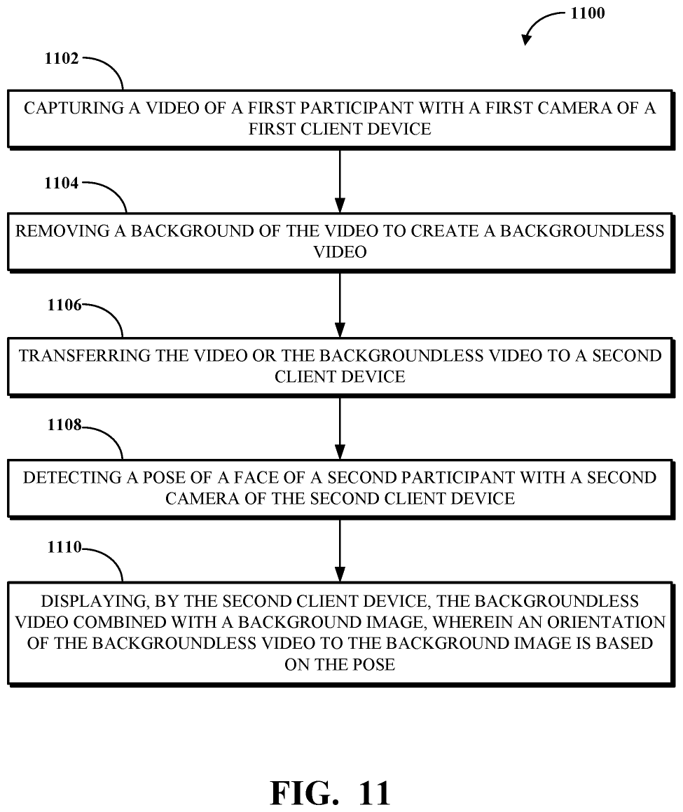

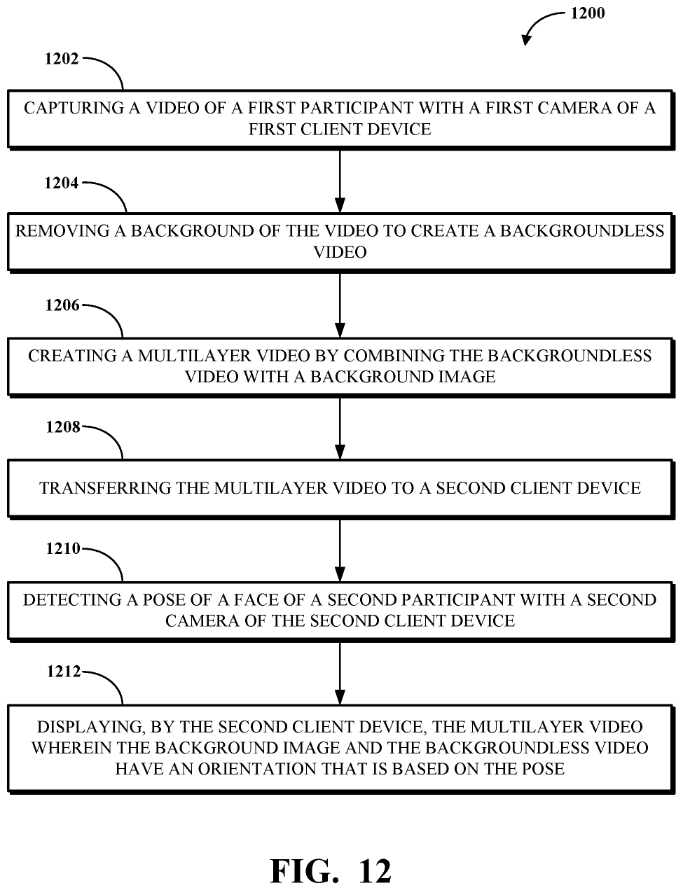

To further describe some implementations in greater detail, reference is next made to examples of techniques 1100 and 1200 which may be performed by or using one or more components of a video-conference system. FIGS. 11 and 12 are respective flowcharts of examples of techniques for simulating depth in a 2D video of a remote speaker via a parallax effect.

The techniques 1100 and 1200 can be executed using computing devices, such as the systems, hardware, and software described or referenced with respect to FIGS. 1-10. The techniques 1100 and 1200 can be performed, for example, by executing a machine-readable program or other computer-executable instructions, such as routines, instructions, programs, or other code. The steps, or operations, of the techniques 1100 and 1200, or another technique, method, process, or algorithm described in connection with the implementations disclosed herein can be implemented directly in hardware, firmware, software executed by hardware, circuitry, or a combination thereof.

For simplicity of explanation, the techniques 1100 and 1200 are depicted and described herein as a series of steps or operations. However, the steps or operations of the techniques 1100 and 1200 in accordance with this disclosure can occur in various orders and/or concurrently. Additionally, other steps or operations not presented and described herein may be used. Furthermore, not all illustrated steps or operations may be required to implement a technique in accordance with the disclosed subject matter. The techniques 1100 and 1200 may be performed by one or more components of video-conferencing system, which may be implemented as a UCaaS platform, such as one or more client devices, such as the computing device 200 of FIG. 2, and one or more servers, such as the application server 108 and/or the database server 110 of FIG. 1.

Referring first to FIG. 11, the step 1102 comprises capturing a video of a first participant with a first camera of a first client device. The first client device may be an instance of the computing device 200 of FIG. 2, and the camera may be an instance of the user interface 212 of the computing device 200. In some implementations, the video is a 2D video.

The step 1104 comprises removing a background of the video to create a backgroundless video. Removing the background may be implemented by software instructions, such as the other software 318 of FIG. 3, executing on a processor of the client device, such as the processor 202 of FIG. 2.

The step 1106 comprises transferring the video or the backgroundless video to a second client device. The second client device may be an instance of the computing device 200 of FIG. 2. The transfer, which may comprise the first client device sending the video or the backgroundless video and the second client device receiving the video or the backgroundless video, may be implemented with network such as the network 114 of FIG. 1. In some implementations, the network is a component of a video-conferencing infrastructure that also includes servers, such as the application server 108 and the database server 110 of FIG. 1. In some implementations, for example where the video is transferred, the second client device performs the removing of the background of the video. In some implementations, for example where the backgroundless video is transferred, the first client device performs the removing of the background of the video.

The step 1108 comprises detecting a pose of a face of a second participant with a second camera of the second client device. The camera may be an instance of the user interface 212 of the computing device 200. The pose may include one or more of a horizontal location, a vertical location, a yaw, a pitch, or a roll.

The step 1110 comprises displaying, by the second client device, the backgroundless video combined with a background image, wherein an orientation of the backgroundless video to the background image is based on the pose. The second client device may comprise or be operatively coupled to a graphical display for displaying the combined video, where the graphical display may be another instance of the user interface 212 of the computing device 200 of FIG. 2. In some implementations, the orientation of the backgroundless video to the background image includes a horizontal orientation and a vertical orientation. An orientation is a positioning of a layer, e.g., of the backgroundless video or the background image, within a viewing window of the graphical display. In some implementations, the background image is obtained from a storage server. In some implementations, the background image is transferred from the first client device to the second client device. In some implementations, the background image comprises a plurality of layers, and an orientation of the backgroundless video to each layer of the background image is based on the pose. In some implementations, the pose is determined by detecting, via the camera, a direction and quantity of pixels that the face has moved relative to a previously detected pose of the face.

Referring now to FIG. 12, the step 1202 comprises capturing a video of a first participant with a first camera of a first client device. The first client device may be an instance of the computing device 200 of FIG. 2, and the camera may be an instance of the user interface 212 of the computing device 200. In some implementations, the video is a 2D video.

The step 1204 comprises removing a background of the video to create a backgroundless video. Removing the background may be implemented by software instructions, such as the other software 318 of FIG. 3, executing on a processor of the client device, such as the processor 202 of FIG. 2.

The step 1206 comprises creating a multilayer video by combining the backgroundless video with a background image. Creating the multilayer video may be implemented by software instructions, such as the other software 318 of FIG. 3, executing on a processor of the client device, such as the processor 202 of FIG. 2.

The step 1208 comprises transferring the multilayer video to a second client device. The second client device may be an instance of the computing device 200 of FIG. 2. The transfer, which may comprise the first client device sending the multilayer video and the second client device receiving the multilayer video, may be implemented with network such as the network 114 of FIG. 1. In some implementations, the network is a component of a video-conferencing infrastructure that also includes servers, such as the application server 108 and the database server 110 of FIG. 1.

The step 1210 comprises detecting a pose of a face of a second participant with a second camera of the second client device. The camera may be an instance of the user interface 212 of the computing device 200. The pose may include one or more of a horizontal location, a vertical location, a yaw, a pitch, or a roll.

The step 1212 comprises displaying, by the second client device, the multilayer video wherein the background image and the backgroundless video have an orientation that is based on the pose. The second client device may comprise or be operatively coupled to a graphical display for displaying the multilayer video, where the graphical display may be another instance of the user interface 212 of the computing device 200 of FIG. 2. In some implementations, the orientation of the backgroundless video to the background image includes a horizontal orientation and a vertical orientation. An orientation is a positioning of a layer, e.g., of the backgroundless video or the background image, within a viewing window of the graphical display. In some implementations, the background image comprises a plurality of layers, and an orientation of the backgroundless video to each layer of the background image is based on the pose. In some implementations, the pose is determined by detecting, via the camera, a direction and quantity of pixels that the face has moved relative to a previously detected pose of the face.

Some implementations of simulating depth in a 2D video using feature detection and parallax effect with a backgroundless video and an out-of-band channel disclosed herein include a method, comprising: capturing a video of a first participant with a first camera of a first client device; removing a background of the video to create a backgroundless video; transferring the video or the backgroundless video to a second client device; detecting a pose of a face of a second participant with a second camera of the second client device; and displaying, by the second client device, the backgroundless video combined with a background image, wherein an orientation of the backgroundless video to the background image is based on the pose.

In some implementations, the orientation includes a horizontal orientation and a vertical orientation.

In some implementations, the background image is obtained from a storage server.

In some implementations, the method further comprises transferring the background image from the first client device to the second client device.

In some implementations, the background image comprises a plurality of layers, and the method further comprises displaying, by the second client device, the backgroundless video combined with the background image, wherein an orientation of the backgroundless video to each layer of the background image is based on the pose.

In some implementations, the method further comprises: detecting the pose of the face by determining a direction and quantity of pixels that the face has moved relative to a previously detected pose of the face; translating the backgroundless video opposite to the direction by a first linear function of the quantity of pixels; and translating the background image in the direction by a second linear function of the quantity of pixels.

In some implementations, the pose comprises at least one of: a horizontal location; a vertical location; a yaw; a pitch; or a roll.

In some implementations, the method further comprises performing a horizontal perspective transformation of the background image according to a yaw of the pose.

In some implementations, the method further comprises performing a vertical perspective transformation of the background image according to a pitch of the pose.

In some implementations, the method further comprises transferring the video or the backgroundless video to the second client device via a video-conferencing infrastructure that includes a network and at least one server.

Some implementations of simulating depth in a 2D video using feature detection and parallax effect with a backgroundless video and an out-of-band channel disclosed herein include a non-transitory computer-readable medium storing instructions operable to cause one or more processors to perform operations comprising: capturing a video of a first participant with a first camera of a first client device; removing a background of the video to create a backgroundless video; transferring the video or the backgroundless video to a second client device; detecting a pose of a face of a second participant with a second camera of the second client device; and displaying, by the client device, the backgroundless video combined with a background image wherein an orientation of the backgroundless video to the background image is based on the pose.

In some implementations, the operations further comprise: transferring the background image from the first client device to a cloud storage; and transferring the background image from the cloud storage to the second client device.

In some implementations, the orientation includes at least one of a horizontal orientation and a vertical orientation.

In some implementations, the background image includes distance information for at least one layer of the background image; and the orientation is further based on the distance information.

In some implementations, the operations further comprise: performing a horizontal perspective transformation of the background image according to a yaw of the pose; and performing a vertical perspective transformation of the background image according to a pitch of the pose.

Some implementations of simulating depth in a 2D video using feature detection and parallax effect with a backgroundless video and an out-of-band channel disclosed herein include a system, comprising: one or more memories; and one or more processors configured to execute instructions stored in the one or more memories to: capture a video of a first participant with a first camera of a first client device; remove a background of the video to create a backgroundless video; transfer the video or the backgroundless video to a second client device; detect a pose of a face of a second participant with a second camera of the second client device; and display, by the client device, the backgroundless video combined with a background image wherein an orientation of the backgroundless video to the background image is based on the pose.

In some implementations, the background image comprises a plurality of layers and includes distance information for every layer, and the instructions include instructions to display, by the second client device, the backgroundless video combined with the background image wherein an orientation of the backgroundless video and each layer of the background image is based on the pose and the distance information.

In some implementations, the orientation includes a horizontal orientation.

In some implementations, the orientation includes a vertical orientation.

In some implementations, the pose comprises: a horizontal location; a vertical location; a yaw; and a pitch.

Some implementations of simulating depth in a 2D video using feature detection and parallax effect with a multilayer video and an in-band channel disclosed herein include a method, comprising: capturing a video of a first participant with a first camera of a first client device; removing a background of the video to create a backgroundless video; creating a multilayer video by combining the backgroundless video with a background image; transferring the multilayer video to a second client device; detecting a pose of a face of a second participant with a second camera of the second client device; and displaying, by the second client device, the multilayer video wherein the background image and the backgroundless video have an orientation that is based on the pose.

In some implementations, the orientation includes a horizontal orientation and a vertical orientation.

In some implementations, the background image is obtained from a storage server.

In some implementations, the background image comprises a plurality of layers, and the method further comprises displaying, by the client device, the multilayer video wherein each layer of the background image and the backgroundless video have an orientation that is based on the pose.

In some implementations, the method further comprises: detecting the pose of the face by determining a direction and quantity of pixels that the face has moved relative to a previously detected pose of the face; translating the backgroundless video opposite to the direction by a first linear function of the quantity of pixels; and translating the background image in the direction by a second linear function of the quantity of pixels.

In some implementations, the pose comprises at least one of: a horizontal location; a vertical location; a yaw; a pitch; or a roll.

In some implementations, the method further comprises performing a horizontal perspective transformation of the background image according to a yaw of the pose.

In some implementations, the method further comprises performing a vertical perspective transformation of the background image according to a pitch of the pose.

In some implementations, the method further comprises transferring the multilayer video to the second client device via a video-conferencing infrastructure that includes a network and at least one server.

In some implementations, the method further comprises: detecting the pose of the face by determining a direction and quantity of pixels that the face has moved relative to a previously detected pose of the face; performing a perspective transformation of the background image based on the direction and the quantity of pixels.

Some implementations of simulating depth in a 2D video using feature detection and parallax effect with a multilayer video and an in-band channel disclosed herein include a non-transitory computer-readable medium storing instructions operable to cause one or more processors to perform operations comprising: capturing a video of a first participant with a first camera of a first client device; removing a background of the video to create a backgroundless video; creating a multilayer video by combining the backgroundless video with a background image; transferring the multilayer video to a second client device; detecting a pose of a face of a second participant with a second camera of the second client device; and displaying, by the second client device, the multilayer video wherein the background image and the backgroundless video have an orientation that is based on the pose.

In some implementations, the orientation includes at least one of a horizontal orientation and a vertical orientation.

In some implementations, the background image includes distance information for at least one layer of the background image; and the orientation is further based on the distance information.

In some implementations, the operations further comprise: performing a horizontal perspective transformation of the background image according to a yaw of the pose; and performing a vertical perspective transformation of the background image according to a pitch of the pose.

In some implementations, the operations further comprise: detecting the pose of the face by determining a direction and quantity of pixels that the face has moved relative to a previously detected pose of the face; translating the backgroundless video opposite to the direction by a first linear function of the quantity of pixels; translating the background image in the direction by a second linear function of the quantity of pixels; and performing a perspective transformation of the background image based on the direction and the quantity of pixels.

Some implementations of simulating depth in a 2D video using feature detection and parallax effect with a multilayer video and an in-band channel disclosed herein include a system, comprising: one or more memories; and one or more processors configured to execute instructions stored in the one or more memories to: capture a video of a first participant with a first camera of a first client device; remove a background of the video to create a backgroundless video; create a multilayer video by combining the backgroundless video with a background image; transfer the multilayer video to a second client device; detect a pose of a face of a second participant with a second camera of the second client device; and display, by the second client device, the multilayer video wherein the background image and the backgroundless video have an orientation that is based on the pose.

In some implementations, the background image comprises a plurality of layers and includes distance information for every layer, and the instructions include instructions to display, by the second client device, the backgroundless video combined with the background image wherein an orientation of the backgroundless video and each layer of the background image is based on the pose and the distance information.

In some implementations, the orientation includes a horizontal orientation.

In some implementations, the orientation includes a vertical orientation.

In some implementations, the pose comprises: a horizontal location; a vertical location; a yaw; and a pitch.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
capturing a video of a first participant with a first camera of a first client device;
removing a background of the video to create a backgroundless video;
transferring the video or the backgroundless video to a second client device;
detecting a pose of a face of a second participant with a second camera of the second client device; and
displaying, by the second client device, the backgroundless video combined with a background image, wherein an orientation of the backgroundless video to the background image is based on the pose.

2. The method of claim 1, wherein:
the orientation includes a horizontal orientation and a vertical orientation.

3. The method of claim 1, wherein:
the background image is obtained from a storage server.

4. The method of claim 1, further comprising:
transferring the background image from the first client device to the second client device.

5. The method of claim 1, wherein the background image comprises a plurality of layers, the method further comprising:
displaying, by the second client device, the backgroundless video combined with the background image, wherein an orientation of the backgroundless video to each layer of the background image is based on the pose.

6. The method of claim 1, further comprising:
detecting the pose of the face by determining a direction and quantity of pixels that the face has moved relative to a previously detected pose of the face;
translating the backgroundless video opposite to the direction by a first linear function of the quantity of pixels; and
translating the background image in the direction by a second linear function of the quantity of pixels.

7. The method of claim 1, wherein the pose comprises at least one of:
a horizontal location;
a vertical location;
a yaw;
a pitch; or
a roll.

8. The method of claim 1, further comprising:
performing a horizontal perspective transformation of the background image according to a yaw of the pose.

9. The method of claim 1, further comprising:
performing a vertical perspective transformation of the background image according to a pitch of the pose.

10. The method of claim 1, further comprising:
transferring the video or the backgroundless video to the second client device via a video-conferencing infrastructure that includes a network and at least one server.

11. A non-transitory computer-readable medium storing instructions operable to cause one or more processors to perform operations comprising:
capturing a video of a first participant with a first camera of a first client device;
removing a background of the video to create a backgroundless video;
transferring the video or the backgroundless video to a second client device;
detecting a pose of a face of a second participant with a second camera of the second client device; and
displaying, by the client device, the backgroundless video combined with a background image wherein an orientation of the backgroundless video to the background image is based on the pose.

12. The medium of claim 11, the operations further comprising:
transferring the background image from the first client device to a cloud storage; and
transferring the background image from the cloud storage to the second client device.

13. The medium of claim 11, wherein:
the orientation includes at least one of a horizontal orientation and a vertical orientation.

14. The medium of claim 11, wherein:
the background image includes distance information for at least one layer of the background image; and
the orientation is further based on the distance information.

15. The medium of claim 11, the operations further comprising:
performing a horizontal perspective transformation of the background image according to a yaw of the pose; and
performing a vertical perspective transformation of the background image according to a pitch of the pose.

16. A system, comprising:
one or more memories; and
one or more processors configured to execute instructions stored in the one or more memories to:
capture a video of a first participant with a first camera of a first client device;
remove a background of the video to create a backgroundless video;
transfer the video or the backgroundless video to a second client device;
detect a pose of a face of a second participant with a second camera of the second client device; and
display, by the client device, the backgroundless video combined with a background image wherein an orientation of the backgroundless video to the background image is based on the pose.

17. The system of claim 16, wherein the background image comprises a plurality of layers and includes distance information for every layer, the instructions including instructions to:
display, by the second client device, the backgroundless video combined with the background image wherein an orientation of the backgroundless video and each layer of the background image is based on the pose and the distance information.

18. The system of claim 16, wherein:
the orientation includes a horizontal orientation.

19. The system of claim 16, wherein:
the orientation includes a vertical orientation.

20. The system of claim 16, wherein the pose comprises:
a horizontal location;
a vertical location;
a yaw; and
a pitch.
